(19) United States
(12) Patent Application Publication
(10) Pub. No.: US 2025/0325851 A1
(43) Pub. Date: Oct. 23, 2025

(54) Harness

(71) Applicant: SKYLOTEC GmbH, Neuwied (DE)

(72) Inventors: Ursula Oberrauch, Villa D’Adda (IT); Brioschi Gianluca, Gorgonzola (IT); Mattia Spada, Lecco (IT)

(21) Appl. No.: 19/184,134

(22) Filed: Apr. 21, 2025

(30) Foreign Application Priority Data
Apr. 22, 2024 (EP) 24 171 703.2

(51) Int. Cl. A62B 35/00

(52) U.S. Cl. CPC A62B 35/0031; A62B 35/0037

(57) ABSTRACT

A harness includes a belt loop, at least one leg loop, each having a first leg loop end and an opposite second leg loop end, at least one leg loop connection element and a belay connection element, wherein the belt loop and the belay connection element are connected to one another, each first leg loop end and the belay connection element are connected to one another, the belt loop and each first leg loop end are configured for alternatively and detachably connecting with the respective second leg loop end via the respective leg loop connection element.

### CROSS-REFERENCE TO RELATED APPLICATIONS

The present application is based upon and claims the right of priority to EP Patent Application No. 24 171 703.2, filed Apr. 22, 2024, the disclosure of which is hereby incorporated by reference herein in its entirety for all purposes.

### FIELD OF INVENTION

The invention relates to a harness including a belt loop, at least one leg loop, each having a first leg loop end and an opposite second leg loop end, and a belay connection element. The invention further relates to a method for putting on a harness including a belt loop, at least one leg loop, each having a first leg loop end and an opposite second leg loop end, and a belay connection element, wherein each first leg loop end and the belay connection element are connected to one another.

### BACKGROUND

A part of safety equipment is designated as a harness, which is worn on a body of a person during climbing, ski touring, mountaineering, via ferrata, tree maintenance, or during work with a risk of falling, and through which a connection is established between the person to be secured and, for example, a safety device to prevent falls or a tie in point.

The harness is generally made from several loops, which are placed around the middle of the body as belt loop respectively hip belt and around legs of the person as leg belts. The loops are brought together at a tie in point, often provided as belay connection element, to which a safety rope or a carabiner may be connected as a safety device against falling. The hip belt, the leg belts, and an optionally present chest strap are adjustable to the bodily dimensions of the person to be secured, so that on the one hand forces occurring between the person and the harness are safely transmitted and, on the other hand, it may be prevented that the person to be secured unintentionally slips out of the harness. Harnesses for climbing in the recreation sector and for industrial safety are basically comparable in structure; however, said harnesses must satisfy different standards. While standard EN 12277 is relevant, for example, in the sporting sector, standard EN 361 applies for harnesses for industrial safety and standard EN 358 applies for tethers.

Harnesses known from prior art are usually designated for a specific use. For example, harnesses designated for climbing can theoretically be used for ski touring, however, harnesses designated for ski touring allow, for example, a greater freedom of movement. On the other hand, a person using the harness often wants to combine said activities i.e. may be forced to change the harness during an activity, for example taking off the ski touring harness for putting on the climbing harness. Such change, however, is impractical and also requires that two different harnesses are carried with.

### SUMMARY OF SOME EMBODIMENTS OF THE INVENTION

It is an object of the invention to provide a harness and a respective method for putting on a harness which can be equally used for different application scenarios, for example both for ski touring and climbing.

The object is solved by the features of the independent claims. Preferred embodiments are described by the features of the dependent claims.

Thus, the object is solved by a harness including a belt loop, at least one leg loop, each having a first leg loop end and an opposite second leg loop end, at least one leg loop connection element and a belay connection element, wherein
the belt loop and the belay connection element are connected to one another,
each first leg loop end and the belay connection element are connected to one another,
the belt loop and each first leg loop end are configured for alternatively and detachably connecting with the respective second leg loop end via the respective leg loop connection element.

It is therefore a key point of the invention to provide a harness which allow for a simple transition from one configuration to another, thereby changing an intended use and affinity of the harness. The proposed harness is thus perfectly applicable for activities where different body positions are required during use, for example from standing on a roof to sitting in the harness for climbing a ladder. The harness thus allows changing its configuration, for example, from a lighter fit during walking, to more support while descending. Furthermore, the harness allows putting on without lifting feet from ground, which is in particular advantageous for soldiers or for a person on a via ferrata i.e. a fixed-rope route. Specifically, when the second leg loop ends are connected to the belt loop, the harness allows easier walking, hiking, trekking or ski touring, as legs are attached higher to the harness. When the second leg loop ends are connected to the first leg loop ends, the harness allows easier climbing, as legs are attached lower to the harness compared to the other configuration.

In other words, the proposed harness is able to modify its load bearing structure while fitted to a user wearing the harness. In particular, the belt loop, which can also be referred to as hip loop, provides for a load distribution along a main structure i.e. the hip of the person so that no interruption of a safety chain occurs when changing the connection of the second leg loop end with respectively between the belt loop and each first leg loop end. In other words, said two configurations can be changed without exiting the harness. On the other hand, the changeable second leg loop end provides a configurable load bearing structure which can be configured respectively set by the user wearing the harness according to a foreseen activity immediately before starting the activity and without undressing. The leg loop connection element allows for an easy change between the two configurations.

The harness can be used for different indoor and outdoor activities, such as for example climbing, mountaineering, walking, hiking, military purposes, ski touring, via ferrata, tree maintenance, or during professional work activities. The belt loop can also be referred to as hip loop and/or is preferably intended and/or sized for being put around the hip of the person wearing the harness. Equally, the leg loops are preferably intended and/or sized for being put around the legs of the person wearing the harness. The harness can be combined with a chest loop attachable to the belt loop.

The belay connection element can be provided as rounded and/or closed belt or strap, which can be worn and/or is textile, for example having a diameter between 5 and 10 cm, and/or as a carabiner, a metal ring and/or a mixture thereof. The belay connection element is intended to connecting the harness with a carabiner, a safety device, a lanyard or the like. In this respect to term connected to one another means preferably that, for example, the belay connection element is fed or passed through the belt loop, preferably in a firmly manner allowing a degree of flexibility between the belay connection element and the belt loop. Generally, the harness is preferably made of textile materials, such as webbings, belts, straps, or the like. The leg loop connection element is preferably configured for providing the alternative and detachably connection between the second leg loop end and the belt loop respectively the first leg loop end. The harness preferably includes an overall weight of ≤200 g, ≤160 g, ≤140 g or ≤100 g.

According to a preferred implementation the at least one leg loop connection element is provided as buckle, in particular as side release buckle or as alamari, as hook, as knot and/or as carabiner with respective eyelet. The buckle can be provided as plastic and/or a metal buckle. One part of the buckle can be firmly attached to the belt loop and the first leg loop end, while another part of the buckle can be firmly attached to the second leg loop end, for example for sewing. The hook and/or the carabiner can equally consist of plastic and/or metal. The eyelet is preferably provided as loop made of a folded strap and/or webbing, which is sewn, for example, onto respectably with the belt loop.

Alamari, also referred to a frog fastener and/or used in nautical devices, is basically a button acting as fastener when inserted into an eyelet. The button can be attached to an end of a strap and/or webbing, while extending perpendicular to an extension of the strap and/or webbing. The alamari can be equipped with a flexible cord, such as a rubber cord or an elastic rope, which can be wound around the alamari and the eyelet when the alamari is inserted into the eyelet for securing the alamari with the eyelet. Alternatively, the loop connection elements can be provided as simple knots.

In another preferred implementation the at least one leg loop connection element includes at least an eyelet attached to the belt loop and to each first leg loop end for connecting with the respective second leg loop. The belt loop may include a plurality of eyelets, for example three eyelets arranged ones besides each other, and/or arranged close to the belay connection element, for example 5 cm close to the belay connection element. Similarly, the eyelet attached to the first leg loop end may be arranged close to the first leg loop end, for example directly at the first leg loop end. The eyelet attached to the first leg loop end of one leg loop may extend parallel and/or opposite to the eyelet attached to the first leg loop end of the another leg loop.

According to a further preferred implementation two first leg loop ends are connected together forming a leg loop connection area connecting the belay connection element. Such wise both two first leg loop ends may be sewed together and/or may be provided as one piece i.e. continuously. The leg loop connection area is preferably intended for connecting the belay connection element. The leg loop connection area can be surrounded by a woven and/or textile leg loop connection webbing, for example extending along 5 to 10 cm.

Preferably the belay connection element is connected to respectively with the leg loop connection webbing. Such leg loop connection webbing may prevent abrasion between the leg loop connection area and the belay connection element.

In another preferred implementation the leg loop connection area is provided as leg connection loop connecting the belay connection element. Therefore, a leg loop strap piece provided a strap and/or webbing can be attached parallel to the leg loop connection webbing, for example being sewed with opposite ends of the leg loop connection webbing and/or both first leg loop ends. The leg loop strap piece may be shorter than the leg loop connection webbing, for example only 5 cm.

According to a preferred implementation the leg loop connection elements include eyelets attached to the leg loop connection area. Said eyelets may be arranged opposite to the leg loop connection area, in particular extending away from the leg loop connection area. Straps and/webbing of the eyelets may be sewed to/with the first leg loop ends and/or surrounded by the textile leg loop connection webbing.

In another preferred implementation the belt loop includes a first belt loop end and an opposite second belt loop end each configured for connecting the with the respective second leg loop end via the respective leg loop connection element. Eyelets may be provided at said first belt loop end and at said second belt loop end. The eyelets preferably extend orthogonal from the belt loop towards the leg loops. The eyelets are preferably sewed to the first belt loop end and at said second belt loop end.

According to a preferred implementation the belt loop includes a belt loop connection area for connecting the belay connection element. Said belt loop connection area is preferably surrounded by a belt loop connection webbing. The belt loop connection webbing is preferably sewed to the belt loop and/or is intended for connecting with the belay connection element. Such belt loop connection webbing may prevent abrasion between the leg loop connection area and the belay connection element.

In another preferred implementation the belt loop connection area is provided as belt connection loop connecting the belay connection element. Such belt connection loop may advantageously hold the belay connection element in its position. According to a preferred implementation the belt loop connection area includes a belt loop connection buckle, in particular a side release buckle, for forming the belt connection loop. The belt loop connection buckle is preferably arranged in parallel to the belt loop connection webbing and/or sewed with the belt loop. By opening and closing the belt loop connection buckle the belay connection element can be connected to the belt loop. Such belt loop connection buckle allows for putting on the harness without removing feet from ground, for example during a ski touring activity.

In another preferred implementation each leg loop includes an interconnecting element for detachably interconnecting the respective first leg loop end and the respective second leg loop end. According to a preferred implementation the interconnecting element includes an interconnecting buckle, in particular a side release interconnecting buckle, or an interconnecting alamari, an interconnecting hook and/or an interconnecting carabiner with a respective interconnecting eyelet. The interconnecting element is preferably includes a strap and/or webbing, to which the interconnecting buckle, the interconnecting alamari, the interconnecting hook and/or the interconnecting carabiner is connected. Preferably the interconnecting element is firmly connected with one end, for example by sewing, to the first leg loop end, in particular distant, for example 5 cm distant thereto, wherein an opposite end is detachably connectable to the second leg loop end, in particular distant, for example 5 cm distant thereto. In this respect the second leg loop end is preferably provided with the interconnecting eyelet.

Preferably, a plurality of interconnecting eyelets are provided at the second leg loop end, more preferably in a row and/or extending away from the second leg loop end. By means of the interconnecting element the person wearing the harness is still connected at its legs with the leg belts, even when changing between the two possible configurations. Such way the interconnecting element, in a walking mode when the second leg loop end is connected with the belt loop, may form a kind of C-shape with other elements of the harness, while in a climbing mode, when the second leg loop end is connected with the first leg loop end, the interconnecting element may form a kind of A-shape with other elements of the harness.

In another preferred implementation the belt loop includes a first belt loop end, an opposite second belt loop end and a belt loop connection element for detachably connecting the first belt loop end and the second belt loop. According to a preferred implementation the belt loop connection element is preferably provided as belt loop buckle, in particular as sliding belt loop buckle. Such way the belt loop can be attached around the hip and/or belt of the person and thereafter fastened by the belt loop buckle to the person.

In another preferred implementation the belt loop and/or the at least one leg loop are provided as flat webbing. The webbing can be provided from a textile material, for example made from sailcloth, by thereby advantageously minimizing weight of the harness. The webbing preferably includes convex isosceles trapezoid like shape with rounded edges. The webbing can be bordered at its both longitudinal edges by a respective folded ribbon, in particular a textile ribbon. Said ribbons are preferably sewed to the flat webbing and/or at its opposite ends, such wise forming, for example the first belt loop end and the opposite second belt loop end.

The object is further solved by a method for putting on a harness including a belt loop, at least one leg loop, each having a first leg loop end and an opposite second leg loop end, at least one leg loop connection element and a belay connection element, wherein
each first leg loop end and the belay connection element are connected to one another, and including the steps of:
Connecting the belt loop and the belay connection element, and
Detachably connecting each second leg loop end via the respective leg loop connection element alternatively to the belt loop or to the respective first leg loop end.

Thereby, connecting the belt loop and the belay connection element can be achieved by closing the belt loop buckle after having inserted the belay connection element into the belt connection loop. Similarly, connecting the second leg loop end alternatively to the belt loop or to the first leg loop end can be achieved by inserting the respective alamari into the respective eyelet. Such method allows first for putting on the harness without removing the feet from ground and second for changing the respective configuration, for example when changing the activity.

Further advantages and embodiments of the method can be derived from the harness as described before.

Other example embodiments of the invention will be described in the following with reference to the figures. It has to be noted that the figures are only provided for illustration of the general concept of the invention by examples not defining the scope of protection of the invention. The figures are not drawn to scale. Features shall not be considered to be essential for the present invention because they are depicted in the figures.

### BRIEF DESCRIPTION OF THE FIGURES

In the figures

FIG. 1 shows an exemplary embodiment according to the invention in a schematic side-view, and

FIG. 2 shows the exemplary embodiment according to the invention in a further schematic side view.

### DETAILED DESCRIPTION OF THE FIGURES

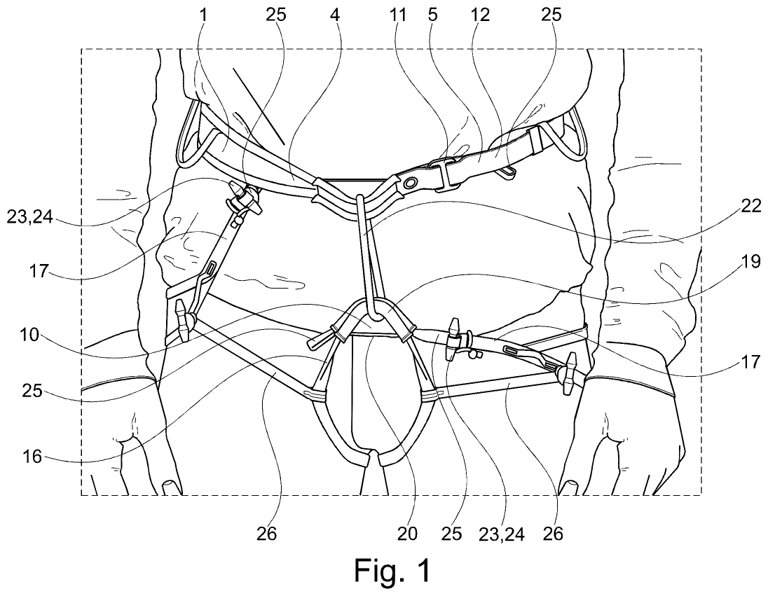

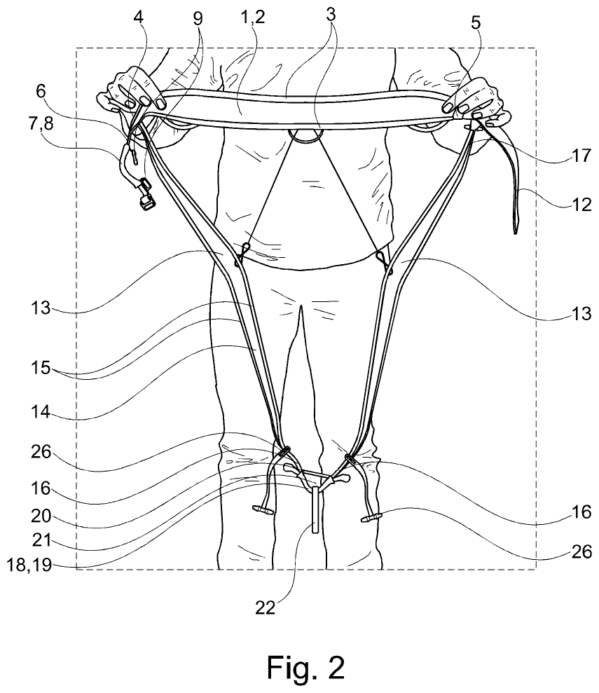

The invention will be described in the following with reference to an exemplary embodiment showing in FIG. 1 a harness worn by a person and in FIG. 2 the unworn harness.

The harness includes a belt loop 1, also referred to as hip loop, which is configured for being worn by the person around a hip and/or belt. The belt loop 1 is provided as flat textile webbing 2 having a convex isosceles trapezoid like shape with rounded edges, as can be seen in FIG. 2. The flat webbing 2 is bordered at its both longitudinal edges by a respective folded ribbon 3, which are sewed to the flat webbing 2. Said two ribbons 3 are sewed together and thus firmly connected together at a first belt loop end 4 and at an opposite second belt loop end 5.

The first belt loop end 4 is sewed and thus firmly connected with a first end of a first flat textile belt piece 6, which forms a belt loop connection area 7, being surrounded by a belt loop connection webbing 8. A belt loop connection buckle 9, which is provided as side release buckle, is connected respectively sewed in parallel to the belt loop connection webbing 8. Thus, by closing the belt loop connection buckle 9 a belt connection loop 10 is formed. A second opposite end of the belt piece 6 is folded and thereafter sewed forming an eyelet. Said eyelet holds two buckles forming a belt loop connection element 11. The second belt loop end 5 is sewed and thus firmly connected with a second flat textile belt piece 12, which is insertable in a sliding manner into the belt loop connection element 11 for such wise forming the closed belt loop 1 when worn by the person, as shown in FIG. 1.

The harness further includes at least one leg loop 13, which, similar as the belt loop 1, are each provided as flat textile leg webbing 14 having a convex isosceles trapezoid like shape with rounded edges, as can be seen in FIG. 2. The flat leg webbing 14 is bordered at its both longitudinal edges by a respective folded leg ribbon 15, which are sewed to the flat leg webbing 14. Each leg loop 13 includes a first leg loop end 16 and an opposite second leg loop end 17, where the two leg ribbons 15 are sewed together. Both first leg loop ends 16 of the at least one leg loop 13 are connected together forming a leg loop connection area 18.

Thereby, the two first leg loop ends 16 can be sewed together or as present provided one-piece i.e. the two leg ribbons 15 surround the two leg webbings 14 of the at least one leg loop 13.

Said leg loop connection area 18 is surrounded by a leg loop connection webbing 19, to which a parallel leg loop strap piece 20 is sewed thereby forming a closed leg connection loop 21. Said leg connection loop 21 is connected to a closed belay connection element 22 made of a sewed belt. Such wise the two first leg loop ends 16 and the belay connection element 22 are connected to one another. When putting on the harness by first putting the belt loop 1 around the hip of the person, second the belay connection element 22 can be attached to the belt loop connection area 7 so that by closing the belt loop connection buckle 9 the belt connection loop 10 is formed such wise connecting the belay connection element 22 and the belt loop 1, so that third the belt loop can be closed respectively fixated to the hip by means of the belt loop connection element 11.

The harness further includes two leg loop connection elements 23, which are provided as alamaris 24 and respective corresponding eyelets 25 into which the alamaris 24. Both second leg loop ends 17 are provided with a respective alamaris 24. Both the first belt loop end 4 and the second belt loop end 5 are provided with a respective eyelet 25. In addition, a respective eyelet 25 is attached to each first leg loop end 16. Said alamaris 24 are provided with a retainer provided as elastic band, which can be wound around the alamari 24 for such wise securing the alamari 24 inserted into the eyelet 25.

Such wise the belt loop 1 and the first leg loop ends 16 can be alternatively and detachably connected with the respective second leg loop ends 17 via the respective leg loop connection element 23, namely by inserting the respective alamaris 24 in the respective eyelet 25. As can be seen from FIG. 1, the left leg loop 13 respectively the alamaris 24 of the second leg loop end 17 of the left leg loop 13 is inserted into the eyelet 25 attached to the first belt loop end 4, wherein the right leg loop 13 respectively the alamaris 24 of the second leg loop end 17 of the right leg loop 13 is inserted into the eyelet 25 attached to the first leg loop ends 16 of the right leg loop 13.

While not shown in the Figs., the loop connection elements 23 can alternatively be provided as buckles, in particular as side release buckles, or as hooks and/or carabiner with corresponding eyelets 25. As can be seen from FIG. 1, the eyelets 25 are provided as folded belts, which are attached respectively sewn to the first leg loop ends 16 and such wise parallel respectively with to the folded leg ribbons 15. Together with the folded leg ribbons 15, the folded belts are surrounded by and respectively sewn with the leg loop connection webbing 19. In this respect the eyelets 25 are provided on opposite sides of leg loop connection area 18.

The harness further includes two interconnecting elements 26, wherein each interconnecting element 26 is detachably arranged between the respective first leg loop end 16 and the respective second leg loop end 17. The interconnecting element 26 is therefore provided as piece of belt firmly connected respectively sewed with one end to the respective first leg loop end 16 and with the another end to an interconnecting alamari attached thereto, which is such wise detachably connectable to an interconnecting eyelet provided at the respective second leg loop end 17. While not directly shown in the Figs. the second leg loop ends 17 are provided with three interconnecting eyelets in a row such that the interconnecting alamari can be connected to any one of these three eyelets. As before, instead of the alamari an interconnecting buckle, in particular provided as side release interconnecting buckle, or an interconnecting hook or an interconnecting carabiner can be used.

Depicted or described connections between components are generally to be understood to be functional connections. They can be implemented as direct links or as indirect links via several other components. The order of presented actions is not mandatory; alternative orders are possible. It is to be understood that the described embodiments are examples only, which may be modified and/or supplemented in many ways within the scope of the claims. In particular, any feature described for a particular embodiment can be used by itself or in combination with other features in any other embodiment. Each feature that has been described for an embodiment of a particular category can also be used in an equivalent manner in an embodiment of any other category.

REFERENCE NUMERALS

| | |
|---|---|
| belt loop | 1 |
| webbing | 2 |
| ribbon | 3 |
| first belt loop end | 4 |
| second belt loop end | 5 |
| first belt piece | 6 |
| belt loop connection area | 7 |
| belt loop connection webbing | 8 |
| belt loop connection buckle | 9 |
| belt connection loop | 10 |
| belt loop connection element | 11 |
| second belt piece | 12 |
| leg loop | 13 |
| leg webbing | 14 |
| leg ribbon | 15 |
| first leg loop end | 16 |
| second leg loop end | 17 |
| leg loop connection area | 18 |
| loop connection webbing | 19 |
| leg loop strap piece | 20 |
| leg connection loop | 21 |
| belay connection element | 22 |
| leg loop connection element | 23 |
| alamari | 24 |
| eyelet | 25 |
| interconnecting element | 26 |

1. A harness comprising a belt loop, at least one leg loop, each having a first leg loop end and an opposite second leg loop end, at least one leg loop connection element and a belay connection element, wherein:
the belt loop and the belay connection element are connected to one another,
each first leg loop end and the belay connection element are connected to one another, and
the belt loop and each first leg loop end are configured for alternatively and detachably connecting with the respective second leg loop end via the respective at least one leg loop connection element.

2. The harness according to claim 1, wherein the at least one leg loop connection element is provided at least one of as buckle, as hook, as knot and as carabiner with respective eyelet.

3. The harness according to claim 1, wherein the at least one leg loop connection element is provided as side release buckle or as alamari.

4. The harness according to claim 1, wherein the at least one leg loop connection element comprises an eyelet attached to the belt loop and to each first leg loop end for connecting with the respective second leg loop end.

5. The harness according to claim 1, wherein two first leg loop ends are connected together forming a leg loop connection area connecting the belay connection element.

6. The harness according to claim 5, wherein the leg loop connection area is provided as leg connection loop connecting the belay connection element.

7. The harness according to claim 5, wherein the leg loop connection elements comprise eyelets attached to the leg loop connection area.

8. The harness according to claim 1, wherein the belt loop comprises a first belt loop end and an opposite second belt loop end each configured for connecting the with the respective second leg loop end via the respective leg loop connection element.

9. The harness according to claim 1, wherein the belt loop comprises a belt loop connection area for connecting the belay connection element.

10. The harness according to claim 9, wherein the belt loop connection area is provided as belt connection loop connecting the belay connection element.

11. The harness according to claim 1, wherein the belt loop connection area comprises a belt loop connection buckle for forming the belt connection loop.

12. The harness according to claim 1, wherein the belt loop connection area comprises a side release buckle for forming the belt connection loop.

13. The harness according to claim 11, wherein each leg loop comprises an interconnecting element for detachably interconnecting the respective first leg loop end and the respective second leg loop end.

14. The harness according to the claim 13, wherein the interconnecting element at least one of comprises and is provided at least one of as interconnecting buckle, as interconnecting hook and as interconnecting carabiner with respective interconnecting eyelet.

15. The harness according to the claim 13, wherein the interconnecting element at least one of comprises and is provided as side release interconnecting buckle or as interconnecting alamari.

16. The harness according to claim 1, wherein the belt loop comprises a first belt loop end, an opposite second belt loop end and a belt loop connection element for detachably connecting the first belt loop end and the second belt loop.

17. The harness according to claim 16, wherein the belt loop connection element is provided as belt loop connection buckle or as sliding belt loop buckle.

18. The harness according to claim 1, wherein at least one of the belt loop and the at least one leg loop is provided as flat webbing.

19. A method for putting on a harness comprising a belt loop, at least one leg loop, each having a first leg loop end and an opposite second leg loop end, at least one leg loop connection element and a belay connection element, wherein:
each first leg loop end and the belay connection element are connected to one another, and comprising the steps of:
connecting the belt loop and the belay connection element together, and
detachably connecting each second leg loop end via the respective at least one leg loop connection element alternatively to the belt loop or to the respective first leg loop end.
